(19) United States
(12) Patent Application Publication
(10) Pub. No.: US 2026/0143355 A1
(43) Pub. Date: May 21, 2026

(54) NETWORK SLICING UPDATE SYSTEM BASED ON DYNAMIC ALLOCATION OF RESOURCES AND METHOD FOR ENSURING HOST MOBILITY USING SAME

(71) Applicant: TRENTO Systems. Inc., Daejeon (KR)

(72) Inventors: YOUNGJAE KIM, Daejeon (KR); YONG-HWAN KIM, Daejeon (KR)

(73) Assignee: TRENTO Systems. Inc., Daejeon (KR)

(21) Appl. No.: 18/963,468

(22) Filed: Nov. 27, 2024

(30) Foreign Application Priority Data
Nov. 15, 2024 (KR) 10-2024-0163308

(51) Int. Cl. H04W 24/02; H04B 17/318; H04W 36/30

(52) U.S. Cl. CPC H04W 24/02; H04B 17/318; H04W 36/302

(57) ABSTRACT

Provided is a network slicing update system based on dynamic allocation of resources and a method for ensuring host mobility using the same. A network slicing update system based on dynamic allocation of resources includes an update request receiving unit that receives network slicing update requests, a target host removal identification and resource release unit that identifies a host to be removed and releases resources based on the update request, and a target host addition identification and resource allocation unit that identifies a host to be added and allocates resources. The method for ensuring host mobility using a network slicing update system based on dynamic allocation of resources includes (a) detecting a movement of a host registered in a network slice, and (b) performing handoff using a data link layer without using an IP address in relation to the host's movement.

### CROSS-REFERENCE TO RELATED APPLICATION(S)

This application claims priority from and the benefit of Korean Patent Application No. 10-2024-0163308, filed on Nov. 15, 2024, which is hereby incorporated by reference for all purposes as if set forth herein.

### BACKGROUND

### 1. Technical Field

The present disclosure relates to a network slicing update system based on dynamic allocation of resources and a method for ensuring host mobility using the same.

### 2. Related Art

According to the related art, Korean Patent No. 10-1754618, a technology for creating a virtual network based on software-defined networks is provided. However, there are issues where network resources are wasted and unnecessary bandwidth is consumed during the management and removal process of multiple links. In addition, the tree generation process is complex when changing network configurations, resulting in performance degradation and inefficient use of network resources.

The related art, Korean Patent Publication No. 10-2020-0011079, discloses a system for upgrading/updating software of a virtual network apparatus/system and a method thereof. This approach maintains service continuity by creating a new apparatus, switching traffic, and then removing the existing apparatus during software updates. However, there is an issue related to performance degradation that occurs during the update process. In addition, there is an issue related to delays that occur at the traffic switching point or the instability of traffic switching.

The related art, Korean Patent Publication No. 10-2018-0122513, discloses a method and a framework for traffic engineering in a network hypervisor of an SDN-based network virtualization platform. This approach requires complex traffic engineering to ensure the communication quality of virtual networks, and has an issue where the mapping of physical paths is not quickly updated when a failure occurs.

The related art, Korean Patent Publication No. 10-2017-0048913, discloses virtualization of network nodes through network function virtualization and utilization of network resources through virtualized network node selection. While this approach offers the advantage of providing flexibility by separating hardware and software, this approach requires complex management due to multiple virtualization layers and various routing path configurations. In addition, when the terminal's location information frequently changes or the network state is unstable, frequent routing changes between network nodes occur, which imposes a burden on system performance.

Handoff in wireless networks is a hard handoff between access points (AP) (or base stations), inevitably resulting in momentary data loss. In a wireless LAN environment, user equipment are assigned IP addresses from an AP or an upper-layer device. Since packets at the IP layer are routed based on destination address. Therefore, when the equipment needs to maintain communication even after moving to a different subnet, the IP address should be changed to one with the network prefix of the relevant network each time the network is changed. In this case, upper-layer connections, such as TCP connections, are not guaranteed, making continuous communication impossible.

Therefore, to maintain communication capability while preserving the existing address, Mobile IP, a layer 3 protocol capable of ensuring mobility, should be used. However, since wireless LAN is not designed to account for data loss compensation, it is unable to support real-time services for upper-layer applications.

In the case of wireless LAN, efficient handoff basically may not be provided without handoff support at layer 2. As described above, the current handoff in wireless LAN supports layer 3 handoff using Mobile IP. However, Mobile IP defines layer 3 handoff (also referred to as loading in wireless LAN) independent of lower layer 2 technologies and does not account for real-time handoff or handoff that supports inter-cell mobility.

Therefore, in wireless network environments with an increasing number of small cells and picocells for high-speed services, and in island-type networks in the form of self-organized networks such as smart cities and autonomous driving, it is necessary to design a handoff scheme at layer 2 (data link layer) based on a dynamic network slicing update system that may support inter-cell mobility while addressing issues related to IP changes.

### SUMMARY

Various embodiments are directed to providing a system and method capable of effectively performing network slicing updates in software-based virtualized network devices that support network slicing and ensuring host mobility by performing high-speed handoff without service interruption through real-time changes to the host's network slice when a host assigned in a network slice moves to a neighboring wireless cell.

The present disclosure relates to a network slicing update system based on dynamic allocation of resources and a method for ensuring host mobility using the same.

A network slicing update system based on dynamic allocation of resources according to an embodiment of the present disclosure includes an update request receiving unit that receives network slicing update requests, a target host removal identification and resource release unit that identifies a host to be removed and releases resources based on the update request, and a target host addition identification and resource allocation unit that identifies a host to be added and allocates resources.

The target host removal identification and resource release unit compares a set of hosts in the previous virtual dedicated network with a set of hosts in the updated virtual dedicated network to identify the host to be removed.

The target host removal identification and resource release unit uses the set difference between the set of hosts in the previous virtual dedicated network and the set of hosts in the updated virtual dedicated network to identify the host to be removed.

The target host removal identification and resource release unit removes flow rules related to the host to be removed and releases unnecessary network resources from the virtual dedicated network.

The target host removal identification and resource release unit removes only flow rules and maintains network resources when the host to be removed is part of an edge switch connected to other hosts in the virtual dedicated network.

The target host addition identification and resource allocation unit uses a set of hosts in the updated virtual dedicated network and a set of hosts in the previous virtual dedicated network to identify the host to be added.

The target host addition identification and resource allocation unit uses the set difference between the set of hosts in the updated virtual dedicated network and the set of hosts in the previous virtual dedicated network to identify the host to be added.

The target host addition identification and resource allocation unit reconfigures a central node when the virtual dedicated network tree is modified by an edge node of the host to be added.

A method for ensuring host mobility using a network slicing update system based on dynamic allocation of resources according to an embodiment of the present disclosure includes (a) detecting a movement of a host registered in a network slice, and (b) performing handoff using a data link layer without using an IP address in relation to the host's movement.

The (a) is detecting the movement of the host by receiving signal strength information from a base station and the host when the host, which refers to the user equipment, moves.

The (a) is detecting the movement of the host based on a signal strength level for initiating handoff tracking.

The (a) is receiving a preparation request to remove the host from a first network slice that the host is previously part of, and a preparation request to add the host to a second network slice that the host is to be part of, based on a change in the received signal strength information.

The (b) is moving the host's MAC address from the MAC layer, which is a lower layer of the data link layer, based on a decrease in the signal strength level of a first base station that corresponds to the first network slice, and an increase in the signal strength level of a second base station that corresponds to the second network slice.

The (b) is performing the handoff based on the signal strength level at the handoff transition point.

The (b) is terminating the handoff based on the received signal power sent from the first base station and the signal strength level at the handoff tracking termination point.

The (b) is receiving environmental variables, including wireless transmission/reception signal strength, interference, and noise, from field equipment, learning the relationship between the environmental variables and handoff performance, and adjusting the received signal strength settings related to the handoff.

In an embodiment, for network slicing updates, instead of completely reconstructing the network tree, selectively updating only the necessary parts enables modification of only the changed parts, thereby significantly reducing the update time.

In an embodiment, during network slicing updates, it is possible to efficiently manage hosts to be removed and added, efficiently recycle resources through the release of network resources for the host to be removed and the additional allocation of resources required for the new host, minimize unnecessary resource usage, and quickly add new resources, thereby enhancing the efficiency of network updates.

In an embodiment, by releasing only the resources related to the removed host and ensuring that communication between other hosts is not affected, the impact on existing network traffic or communication paths during the network slicing update process is minimized, thereby maintaining network performance.

In an embodiment, during the network slicing update process, selectively processing only the parts that need updating and quickly applying the newly calculated paths allows for minimizing service delay and interruption times and improving service quality of experience for users. In addition, by designing the update process to occur within the acceptable service range, the negative impact on users may be minimized.

In an embodiment, in the case of adding a new host or removing an existing host, network resources are immediately reallocated, thus enabling flexible updates to the virtual network in response to new user requirements, dynamically meeting user requirements, and adapting to the real-time changing network environment.

In an embodiment, when updating network slicing, updating security rules and flow information related to each host ensures that network isolation and security are maintained after the update, allowing for stable network operation without security risks. After the network slicing update, the resources of the removed host are completely released, and only the resources for the new host are added, thereby enhancing security.

In an embodiment, through the network slicing-based mobile communication network configuration, latency is reduced by enabling inter-cell handoff based on network slices without passing through layer 3, allowing for seamless and high-speed handoff in real-time services such as autonomous driving and remote healthcare, even in devices like wireless LANs.

In an embodiment, by sharing network facilities at layer 2 level and exchanging control between base stations, mobility may be controlled within the company's network, allowing for independent network operation. This supports independent inter-cell mobility without incurring additional costs, resulting in high economic efficiency.

In an embodiment, by supporting handoff between densely packed wireless cells at layer 2, a large number of terminals may ensure seamless connectivity independent of IP with assured performance.

In cases where a Multi WiFi AP network is built using a mesh topology in wireless LANs, there are limitations for real-time services due to latency issues caused by routing during wireless relay. However, according to the present disclosure, by configuring the Multi WiFi AP network based on network slicing, it is possible to provide continuous service even during inter-cell movement, minimize shadow areas without delay, and ensure connection reliability.

In an embodiment, through equations for the handoff tracking point and handoff transition point, it is possible to autonomously monitor changes in cell coverage based on environmental changes (such as cell additions, seasonal variations in signal strength, etc.). By updating the received signal strength for handoff in real-time through intelligent radio control and monitoring functions, the handoff success rate may be increased while minimizing human error caused by manual intervention.

The effects of the present disclosure are not limited to the above-mentioned effects, and the other effects which are not mentioned herein will be clearly understood from the following descriptions by those skilled in the art.

### BRIEF DESCRIPTION OF THE DRAWINGS

FIG. 1 shows the configuration of a network slicing update system based on dynamic allocation of resources according to an embodiment of the present disclosure.

FIG. 2 shows a selective virtual dedicated network (VDN) reconfiguration process according to an embodiment of the present disclosure.

FIG. 3 shows a VDN update algorithm according to an embodiment of the present disclosure.

FIGS. 4A to 4D show a selective VDN reconfiguration process according to an embodiment of the present disclosure.

FIG. 5 shows the configuration of a handoff system at L2 layer based on network slicing according to an embodiment of the present disclosure.

FIG. 6 shows a high-speed handoff process based on network slicing according to an embodiment of the present disclosure.

FIG. 7 shows a handoff process based on network slicing according to an embodiment of the present disclosure.

FIG. 8 shows signal strength tracking for a soft handoff according to an embodiment of the present disclosure.

FIG. 9 shows an initial signal strength configuration process for handoff according to an embodiment of the present disclosure.

FIG. 10 shows a signal strength tracking and transition process for a soft handoff according to an embodiment of the present disclosure.

FIG. 11 shows an intelligent radio controller operation process for increasing the accuracy of a soft handoff equation according to an embodiment of the present disclosure.

FIG. 12 is a block diagram showing a computer system for implementing a method according to an embodiment of the present disclosure.

### DETAILED DESCRIPTION

The above-described objectives of the present disclosure, along with other objectives, advantages and features of the present disclosure and methods of achieving the same will become apparent with reference to the embodiments described in detail below in conjunction with the accompanying drawings.

However, the present disclosure is not limited to the embodiments disclosed below and may be implemented in various other forms. The following embodiments are provided merely to facilitate an understanding of the objectives, configuration, and effects of the disclosure to those skilled in the art, and the scope of the present disclosure is defined by the appended claims.

Terms used in the present specification are used for describing embodiments, not limiting the present disclosure. The terms of a singular form in the present specification may include plural forms unless specifically mentioned. The terms “comprise” and/or “comprising” used in the specification do not exclude the presence or addition of one or more other components, steps, operations, and/or elements beyond those specifically mentioned.

In the following, the background and embodiments of the present disclosure are described to assist those skilled in the art in understanding.

A software-defined network (SDN) is defined as a technology that separates the control function of data flow in a network from physical network devices, allowing centralized network control and programming. In the network structure according to the related art, each network device operates independently, and switches and routers that constitute the network manage traffic separately. According to the related art, as the complexity of the network increases, the limitations of control become apparent. The SDN may dynamically manage network resources through a centralized controller to address the control limitations of the related art. In an embodiment of the present disclosure, an SDN-based network slicing technology is provided to enable more efficient resource allocation and management in a virtualized network, and improve flexibility and efficiency of the network through a selective network slicing update.

Network slicing is defined as a technology that divides a physical network into multiple virtual networks (slices), allowing each slice to operate as an independent network. Network slicing is mainly deployed in the core of 5G/6G networks, where each slice needs to be customized to meet the requirements of a specific service or application. The 5G network is designed to meet various service requirements, such as ultra-low latency, high bandwidth, and high reliability. Each slice may be allocated a dedicated resource to meet service requirements, thereby ensuring communication quality. In an embodiment of the present disclosure, in terms of network slicing update, there is a technical feature that maximizes network resource efficiency, maintains network quality, and meets dynamic service requirements by removing unnecessary resources in a slice and dynamically allocating a new resource while maintaining the performance of the slice.

Network virtualization is defined as a technology that abstracts physical resources to make them available as multiple virtual resources. Virtualization technology was developed to efficiently utilize resources. Virtualized network devices may overcome the limitations of physical devices, allowing multiple users to share the same physical resource, while each user may utilize this resource as if it were an independent resource. In an embodiment of the present disclosure, a system is provided that efficiently allocates and updates network resources by combining SDN and network slicing in virtualized network environments. In an embodiment of the present disclosure, by effectively processing software updates of a virtualized network device, it is possible to maintain network performance without service interruptions.

5G/6G networks are next-generation communication technologies developed with the aims of ultra-low latency, high reliability, and large-capacity data transmission. These networks enable the realization of various applications, such as autonomous driving, smart factories, and AR/VR, which were difficult to achieve in traditional communication environments. The 5G network is designed with the consideration that different kinds of terminals need to maintain high-quality communication while moving, making mobility management a critical issue. It is necessary for each terminal to seamlessly move between network slices. In an embodiment of the present disclosure, by providing a network slicing-based handoff technology for supporting mobility of terminals in a 5G network, there is a technical feature that enables seamless switch between network slices when the terminal moves, and performs real-time mobility management and resource reallocation.

Network security is a critical element in network slicing and virtualization environments. In large-scale networks like 5G, ensuring the safety of data transmission and the protection of network resources is a highly important task. The related art emphasizes physical security in networks, but with the introduction of virtualization and SDN, the scope of security threats has broadened. In virtualized environments, access control to network resources and data protection are more critical issues. In an embodiment of the present disclosure, a security mechanism is provided to enhance the isolation and security between network slices, thereby independently protecting each slice and preventing unauthorized access to network resources. In an embodiment of the present disclosure, a method is provided to minimize security threats during the network resource update process. When security breaches occur in a network that ensures network slicing, resilience technology is applied by isolating a security target network resource, allocating a new resource, and performing slicing updates for security responses such as isolation and service recovery, thereby ensuring service resilience.

Automation technology maximizes efficiency by automatically processing the allocation and management of network resources. In network slicing and virtualized network environments, dynamic allocation and real-time updating of resources become critical factors. As network complexity increases, the manual management of network resources has reached its limitations. To address this issue, the integration of SDN and orchestration technology enables the automatic allocation and management of network resources. In an embodiment of the present disclosure, there is a technical feature that enables the automation of network resource updates and allocation, allowing for efficient resource management while maintaining network performance through the application of SDN-based network slicing technology.

In an embodiment of the present disclosure, a network slicing update system is provided to effectively perform network slicing updates in software-based virtualized network devices that support network slicing.

In addition, through the network slicing update system according to an embodiment of the present disclosure, a method is provided to perform a high-speed handoff without service interruption by changing a host's network slice in real-time when the host allocated to network slicing moves to a neighboring wireless cell, thereby ensuring host mobility.

In an embodiment of the present disclosure, dynamic allocation and updates of resources in the network slice enable the maintenance of network performance and improve resource efficiency. The 5G/6G networks should be designed to divide and manage resources through network slicing to meet various services and user requirements. Dynamic allocation and release of network resources enables efficient utilization of resources, while releasing unnecessary resources reduces network resource waste.

In an embodiment of the present disclosure, it is possible to safely update the software of virtualized network devices while minimizing service interruptions. According to the related art, service interruptions or performance degradation occur during software updates. In contrast, according to an embodiment of the present disclosure, network slicing updates are performed in a manner that allows services unrelated to the network devices and user equipment that require slice changes to be provided without interruption.

According to an embodiment of the present disclosure, it is possible to maintain service quality by seamlessly switching network slices of moving terminals. The 5G/6G networks aim to provide uninterrupted service when user equipment moves. Mobility management functions enable seamless switching between network slices even when the terminal moves across the network.

According to an embodiment of the present disclosure, network slicing is flexibly managed in the 5G network to meet various service requirements, thereby enabling real-time traffic management and optimization. To maintain network performance, it is crucial to manage the traffic that occurs in network slices in real time and reallocate resources based on traffic volume. Traffic monitoring and management functions enable effective control of traffic in the slice and dynamic allocation of necessary resources to optimize network performance.

According to the present disclosure, it is possible to maintain security between slices and minimize security threats that may occur during the network resource update process. A security resilience method is provided to enable network isolation in response to cyberattacks and optimize network/service recovery performance through selective network slice control for terminal/application services where cyber threats are detected, thereby improving the service's connection survivability.

In the following description, network slice (NS), virtual network, and virtual dedicated network (VDN) are used interchangeably.

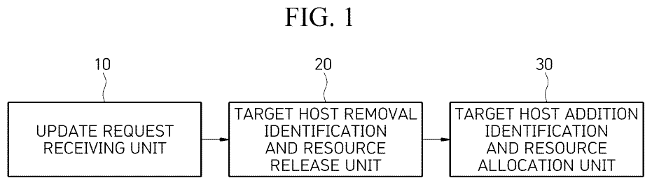

FIG. 1 shows the configuration of a network slicing update system based on dynamic allocation of resources according to an embodiment of the present disclosure.

A network slicing update system based on dynamic allocation of resources according to an embodiment of the present disclosure includes an update request receiving unit 10 that receives network slicing update requests, a target host removal identification and resource release unit 20 that identifies a host to be removed and releases resources, and a target host addition identification and resource allocation unit 30 that identifies a host to be added and allocates resources. The components according to an embodiment of the present disclosure may be provided as separate, independent modules or as modules in which each function is combined. In addition, the above-described update request receiving unit 10, target host removal identification and resource release unit 20, and target host addition identification and resource allocation unit 30 may be provided as components included in a SDN controller.

The target host removal identification and resource release unit 20 receives the update request, compares a set of hosts in the previous virtual dedicated network with a set of hosts in the updated virtual dedicated network, and identifies the host to be removed. In this case, the target host removal identification and resource release unit 20 identifies the host to be removed by using the set difference between the set of hosts in the previous virtual dedicated network and the set of hosts in the updated virtual dedicated network. The target host removal identification and resource release unit 20 removes flow rules related to the host to be removed and releases unnecessary network resources from the virtual dedicated network. When the host to be removed is part of an edge switch connected to other hosts in the virtual dedicated network, the target host removal identification and resource release unit 20 performs only flow rule removal and maintains network resources.

The target host addition identification and resource allocation unit 30 identifies a host to be added by using the set of hosts in the updated virtual dedicated network and the set of hosts in the previous virtual dedicated network. In this case, the target host addition identification and resource allocation unit 30 identifies the host to be added by using the set difference between the set of hosts in the updated virtual dedicated network and the set of hosts in the previous virtual dedicated network. The target host addition identification and resource allocation unit 30 allocates network resources required for the host to be added. When the virtual dedicated network tree is modified by an edge node of the host to be added, the target host addition identification and resource allocation unit 30 reconfigures a central node.

The configuration of a network slicing update system based on dynamic allocation of resources according to an embodiment of the present disclosure will be described below.

### SDN Controller

The SDN controller, as the central control device of the network, manages all resources of the physical and virtual networks and controls network traffic. The SDN controller collects information about hosts, switches, and links from the physical network, configures and controls the virtual network, and manages network traffic in real-time in response to user requirements.

### Data Plane

The data plane is composed of physical network devices (such as switches, routers, etc.) that form the path through which actual data is transmitted. The data plane configures traffic paths in the physical network and forwards packets according to the SDN controller's specifications.

### Virtual Network Management System

The virtual network management system is a system that dynamically creates, updates, and removes virtual networks for management purposes. This system is integrated with the SDN controller to automate the control of virtual networks and allocates resources in response to user requirements. The virtual network management system allocates resources used in the virtual network and dynamically adjusts these resources based on the network status.

### Network Slicing Module

The network slicing module is integrated with the virtual network management system, divides a single physical network into multiple virtual networks, and each slice is used as an independent network resource. The network slicing module divides the network in response to various user requirements and allocates dedicated resources to each slice, thereby enabling independent network traffic management. The network slicing module provides network isolation for enhanced security and enables safe data processing without interference between slices.

### Resource Allocation Module

The resource allocation module dynamically allocates network resources required during the creation and update of virtual networks. The resource allocation module selects and allocates resources such as links, bandwidth, and switches required for the virtual network in response to user requirements, thereby ensuring the performance and stability of the network. The resource allocation module minimizes the use of unnecessary resources and optimizes network performance by efficiently reallocating available resources.

### Network Tree Construction Module

The network tree construction module constructs a network tree based on information provided by the SDN controller. The network tree construction module calculates the most efficient path in the network and constructs a network tree based on the shortest path that connects each host and switch.

### Security and Policy Management Module

The security and policy management module is a module that maintains the security of virtual networks and manages network policies, and applies security policies during network slicing and resource allocation. The security and policy management module performs security isolation between virtual networks, user authentication, and authorization control, and ensures the integrity and safety of network traffic. The security and policy management module provides whitelist-based network slicing security, thereby restricting network access to only authorized users or devices.

### Open Interface

The open interface is an interface that enables external systems or user/network administrators to easily create and manage virtual networks.

The open interface may allow users to easily perform network creation, update, and removal requests, resource allocation, and network status monitoring requests. The open interface may enable visual monitoring of network status and performance in real time, thereby enhancing management efficiency.

The requirements related to a selective update of network slices according to an embodiment of the present disclosure are described below.

After network slicing updates, all hosts in the updated virtual dedicated network should be able to communicate seamlessly with each other. This enables the updated virtual dedicated network to continuously provide uninterrupted connectivity between hosts.

End-to-end paths between hosts in the updated virtual dedicated network require necessary bandwidth support. The updated virtual dedicated network needs to provide sufficient network capacity and performance to meet service level agreements or user expectations.

Communication between the previous virtual dedicated network hosts/services, excluding removed hosts, should not be affected by the update, and it is necessary to maintain network connectivity and performance for the hosts/services unaffected by the update.

The update process of the virtual dedicated network should be performed within the acceptable service range, which means that the update should not significantly degrade the quality of service provided to the user. The update should be performed in a way that minimizes the impact on ongoing network services.

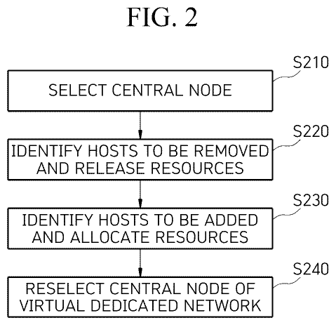

A selective virtual dedicated network (VDN) reconfiguration process is described below with reference to FIG. 2.

### Selecting a Central Node (S210)

A central node with the highest closeness centrality is identified in the virtual dedicated network to be updated. Closeness centrality is a metric used in network analysis to measure how close a specific node is to other nodes. This closeness centrality is calculated based on the average distance from one node to all other nodes in the network and may be used to determine how quickly information may be transmitted from that node to other nodes. As a node that may reach other nodes via the shortest path in the network, the central node serves as the key component during virtual dedicated network updates. When there are no significant changes in the network, the central node reselection process may be omitted.

### Identifying Hosts to be Removed and Releasing Resources (S220)

Hosts to be removed (Hr) are identified based on the update request. According to an embodiment of the present disclosure, a set of hosts in the previous virtual dedicated network (Hp) and a set of hosts in the updated virtual dedicated network (Hv) are compared to determine unnecessary hosts from the previous set of hosts. Flow rules related to the hosts are removed and unnecessary network resources are released from the virtual dedicated network, thereby releasing the network resources related to the identified host to be removed. If the host is still part of an edge switch connected to other hosts in the virtual dedicated network, only the host information and flow rules are removed, and the network resources are maintained.

### Identifying Hosts to be Added and Allocating Resources (S230)

Hosts to be added (Ha) are identified. It is determined by comparing the set of hosts in the updated virtual dedicated network (Hv) with the set of hosts in the previous virtual dedicated network (Hp). Network resources required for the host to be added are allocated, new paths are configured, and necessary resources are allocated for communication with the host to be added. When the host is already part of an existing path, existing resources are used without additional path configuration.

### Reselecting a Central Node of Virtual Dedicated Network (S240)

When there is a change in the virtual dedicated network topology, a central node is reselected. By reselecting the most suitable central node in the new network structure, it is possible to maintain efficient network configuration even after updating the virtual dedicated network.

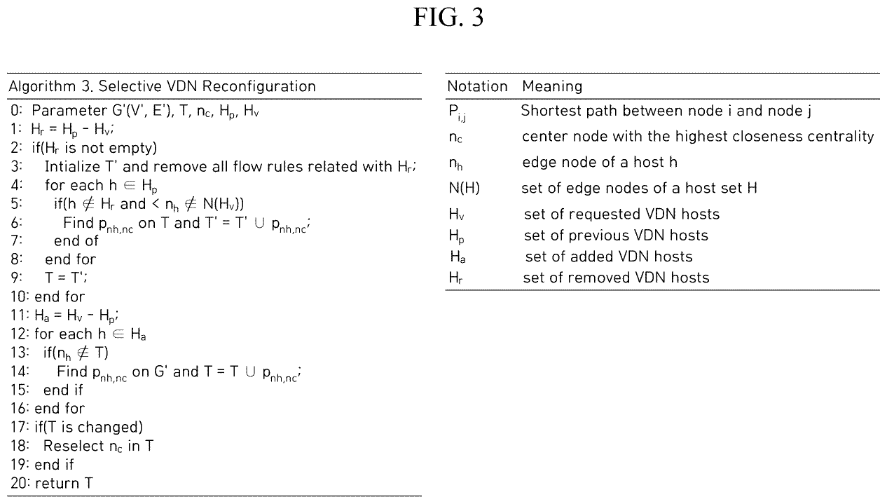

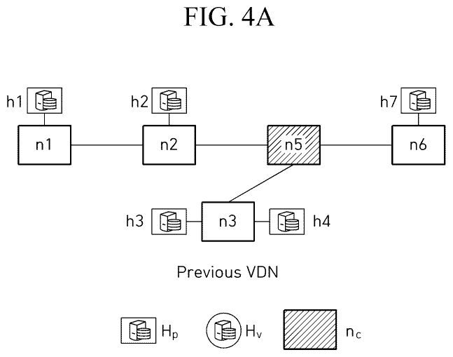

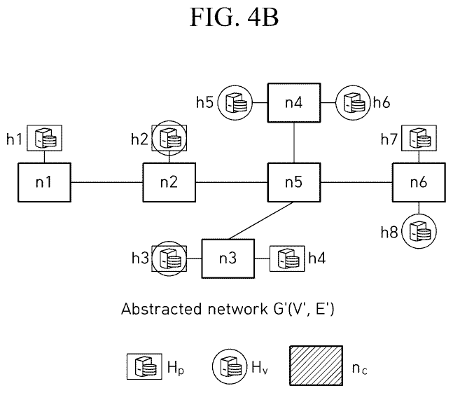

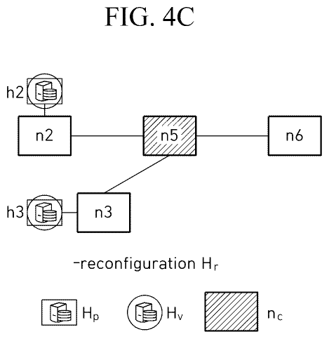

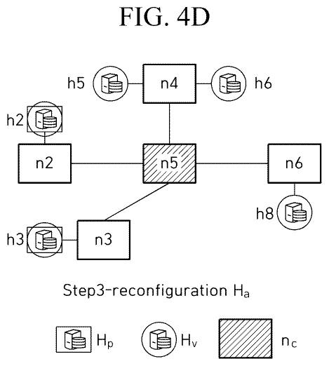

FIG. 3 shows a VDN update algorithm according to an embodiment of the present disclosure. FIGS. 4A to 4D shows an example of a selective VDN reconfiguration process according to an embodiment of the present disclosure.

Hp (set of hosts in the previous virtual dedicated network) is {h1, h2, h3, h4, h7}, Hv (set of hosts in the updated virtual dedicated network) is {h2, h3, h5, h6, h8}, Ha (set of hosts to be added) is {h5, h6, h8}, and Hr (set of hosts to be removed) is {h1, h4, h7}.

As described above, hosts to be removed are identified and resources are released at step S220. First, Hr (set of hosts to be removed) is identified from the removed virtual dedicated network. Based on this, the network resources related to Hr (set of hosts to be removed) are released from the virtual dedicated network. Hr (set of hosts to be removed) is determined by comparing the set of requested hosts in the VDN with the set of hosts in the previous VDN, Hp. Given Hv (set of hosts in the updated virtual dedicated network) and Hp (set of hosts in the previous virtual dedicated network), Hr (set of hosts to be removed) is defined as the set difference obtained by subtracting Hv (set of hosts in the updated virtual dedicated network) from Hp (set of hosts in the previous virtual dedicated network). Referring to FIGS. 4A to 4D, Hp (set of hosts in the previous virtual dedicated network) is {h1, h2, h3, h4, h7} and Hv is {h2, h3, h5, h6, h8}, so Hr (set of hosts to be removed) is denoted as {h1, h4, h7}. If Hr (set of hosts to be removed) is empty, there is no need to perform step S220. If Hr (set of hosts to be removed) is identified, all flow rules related to Hr (set of hosts to be removed) are removed from the SDN nodes in the virtual dedicated network. In addition, the network resources related to Hr (set of hosts to be removed) should also be released from the virtual dedicated network. However, if an edge node nh connected to Hr (set of hosts to be removed) is included in N (Hv, set of hosts in the updated virtual dedicated network), this procedure is unnecessary because the edge node is also used for hosts of other virtual dedicated networks in Hv (set of hosts in the updated virtual dedicated network). Therefore, only the flow rules related to the removed hosts (h4, h7) are removed. If the edge node nh connected to Hr (set of hosts to be removed) is not included in N (Hv, set of hosts in the updated virtual dedicated network), such as in the case of h1, network resources related to the removed host, such as the edge node, are released. If nodes and links related to the remaining hosts in the virtual dedicated network are included in the path between the edge node and the central node of the removed host, those nodes and links may also be removed. Therefore, the shortest path is calculated between nc and N(Hp) for all hosts of in the set Hp (set of hosts in the previous virtual dedicated network), and the calculated paths are integrated into the updated virtual dedicated network.

As described above, hosts to be added are identified, and resources are allocated at step S230. At step S230, the added hosts Ha (hosts to be added) are processed. First, the set of added hosts Ha in the virtual dedicated network is identified, and network resources are allocated for the hosts in Ha (hosts to be added). Given Hv (set of hosts in the updated virtual dedicated network) and Hp (set of hosts in the previous virtual dedicated network), Ha (hosts to be added) is defined as the set difference obtained by subtracting Hv (set of hosts in the updated virtual dedicated network) from Hp (set of hosts in the previous virtual dedicated network), and Ha (hosts to be added) is denoted as {h5, h6, h8}. If Ha (hosts to be added) is empty, there is no need to perform step S230 for the added hosts. The reconfiguration process for Ha (hosts to be added) is simpler than that for Hr (set of hosts to be removed). After calculating the new shortest path between the central node nc and N(Ha) in the abstracted network, this calculated path is integrated into the virtual dedicated network. If the edge node nh of the added host is already part of T, there is no need to integrate the path related to nh. Therefore, the reconfiguration process of Ha (hosts to be added) is performed after the reconfiguration of Hr (set of hosts to be removed). If T is changed, a new central node nc is selected again based on the updated virtual dedicated network. Regarding processing time, the maximum number of shortest path calculations for each step may be expressed as |N(Hp)|−|N(Hh)| and |N(Ha)|, respectively. In real-world environments, most users reside at the same site (e.g., headquarters, branch offices, key partners), so the addition and removal of edge nodes is infrequent after the virtual dedicated network, including edge nodes, is established. This means that the reconfiguration of the virtual dedicated network may be completed by changing the set of hosts in the virtual dedicated network, except when new path calculations are required.

The application of cybersecurity resilience according to an embodiment of the present disclosure is described below. According to an embodiment of the present disclosure, network slicing (NS) updates are performed based on the detection of network slice change factors.

According to an embodiment of the present disclosure, in a network that ensures network slicing connected to a 5G core, security breaches are monitored in an integrated manner, survivability is ensured, and resilience measures are provided for security responses (such as isolation, service recovery, etc.) when security breaches are detected. In addition, unnecessary terminals and application services are removed during network slicing reconfiguration, the network resources used during this reconfiguration are released, and new resources are efficiently reallocated, thereby ensuring network flexibility through service recovery.

According to an embodiment of the present disclosure, for security response, the terminal and application services to be removed are identified, and network resources related to the virtual dedicated network are released. The terminal/application services to be removed are queried in the virtual dedicated network, and the network resources (including network device flows) related to the terminal/application services are released from the virtual dedicated network. In this case, as described above, network resources are released by comparing the requested virtual dedicated network's terminal/application service set with the previous virtual dedicated network's terminal/application service set. During the virtual dedicated network reconfiguration process, unnecessary terminal/application services may be removed, and related network resources may be released, thereby enabling efficient resource reallocation and ensuring network flexibility.

According to an embodiment of the present disclosure, terminal/application services to be added for service continuity are identified, and network resources related to the virtual dedicated network are allocated. To support new user requirements, the set of terminal/application services to be added to the virtual dedicated network is identified, and the necessary network resources are allocated to the set. This enables the virtual dedicated network to flexibly respond to new user requirements and allows for dynamic updates of the virtual dedicated network.

According to an embodiment of the present disclosure, a network slicing-based handoff implementation method is provided that, unlike existing devices, supports high-speed handoff between cells while ensuring the performance (QoS) of requested services regardless of IP changes even after movement, in a small cell environment providing high-speed data services. In addition, according to an embodiment of the present disclosure, a method is provided for tracking the received signal strength from a high-speed service cell in overlapping cell areas where handoffs occur and determining the received signal strength for the handoff. According to an embodiment of the present disclosure, it is possible to independently provide seamless data services to user equipment, regardless of IP, even when the service cell size changes due to a surge in users while moving.

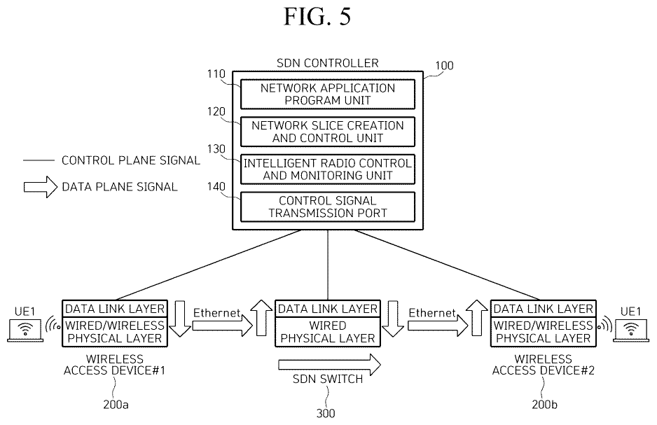

The configuration of a handoff system at L2 layer based on network slicing according to an embodiment of the present disclosure is described below with reference to FIG. 5.

According to an embodiment of the present disclosure, a handoff system based on network slicing is a structure for virtualizing/abstracting wireless terminals and the communication network resources that connect therebetween. Software functions embedded in hardware are implemented as software in a central control unit, and the hardware is implemented as white-box hardware or commercial off-the-shelf (COTS) servers, thus avoiding issues related to parts replacement and manufacturer dependency.

In a structure according to an embodiment of the present disclosure, the basic hardware configuration includes a SDN controller 100 (network central control device) based on a software defined network (SDN), wireless access devices 200a and 200b, and an SDN switch 300 (network device) responsible for data transmission in the network. The communication between these components is functionally separated into a data plane path and a control plane path.

In the network, the data plane performs transmitting actual traffic across network devices (including functions such as receiving, forwarding, and transmitting packets). The data plane performs moving data along a physical path of the network or, when necessary, a virtual dedicated path (network slice).

The control plane performs managing and controlling a session and traffic flow of the network. The control plane determines the network topology inside the vehicle, configures network slices (paths), and applies handoff policies. The control plane operates on the SDN controller 100 and issues commands to the wireless access devices 200a and 200b, SDN switch 300, user equipment (UE), and other network devices to ensure that the data plane operates properly.

According to an embodiment of the present disclosure, it is possible to connect networks and transmit data at high speed by performing handoff using only the data link layer (layer 2) of the seven layers of OSI without relying on IP. According to an embodiment of the present disclosure, the data plane and control plane are separated to configure a network slice, which is a logical network dedicated to a wireless terminal. Data transmission is performed along the network slice to ensure L2-based high-speed handoff, transmission speed (bandwidth), communication latency, and other factors, thereby ensuring the service performance (QoS) for wireless terminal communication.

The SDN controller 100 includes a network application program unit 110, a network slice creation and control unit 120, an intelligent radio control and monitoring unit 130, and a control signal transmission port 140.

The network application program unit 110 virtualizes and adds network functions, and supports designers or operators in virtualizing and adding network functions such as DHCP, firewall, and NAT.

The network slice creation and control unit 120 performs terminal and network device authentication, session configuration, and path creation functions, and dynamically creates a virtual dedicated network (virtual dedicated path, network slice) from the terminal to the network service end on a physical Ethernet cable line. The network slice creation and control unit 120 controls and manages data through the virtual dedicated network (network slice) based on terminal requests, and ensures QoS of data traffic in wired and wireless networks to perform dynamic virtual path creation, modification, and management, device authentication, and session configuration.

The intelligent radio control and monitoring unit 130 monitors environmental variables such as wireless transmit/receive signal strength, interference, and noise, and provides feedback to base stations and terminals to improve the accuracy of measured values in order to determine real-time handoff performance.

The control signal transmission port 140 transmits control signals.

The SDN controller 100 executes the software that performs the network's main functions (path computation, routing). The SDN switch 300 serves as a data transmission switch, which is connected to the SDN controller 100 through the control plane communication channel and uses a flow table at the data link layer for data transmission. In addition, the SDN switch 300 performs data transmission through Ethernet ports at wired and wireless physical layers. This SDN switch 300 may be implemented on COTS servers or white-box switches.

The wireless access devices 200a and 200b are mobile communication base stations or wireless LAN access point (AP) devices for providing mobile communication services. These wireless access devices receive the wireless data from the user equipment (UE), forward the data to the SDN switch 300, and provide handoff tracking and received signal strength monitoring functions.

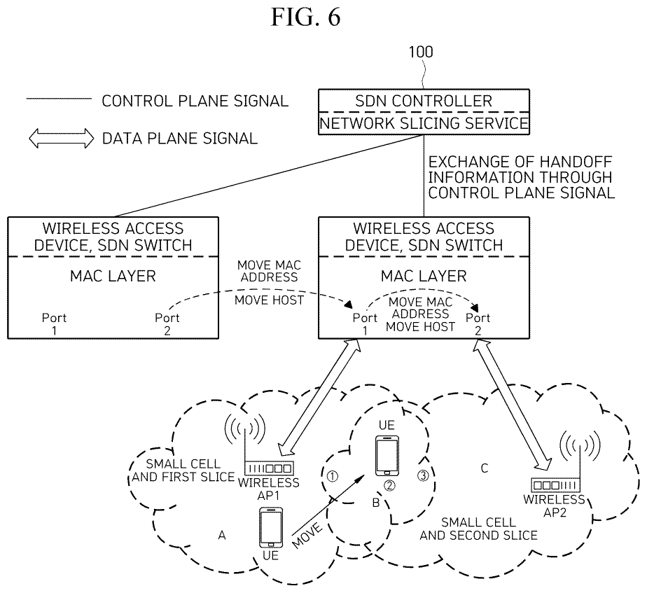

A high-speed handoff process based on network slicing according to an embodiment of the present disclosure is described in detail below with reference to FIG. 6, in particular, a MAC address registration procedure and a host update procedure in a network slice when performing handoff based on inter-cell movement in a wireless device.

Referring to FIG. 6, the user equipment (UE) moves from wireless AP1 cell A to area B, which overlaps with another wireless AP cell. The SDN controller 100 updates the information related to the equipment's inter-cell movement in real-time.

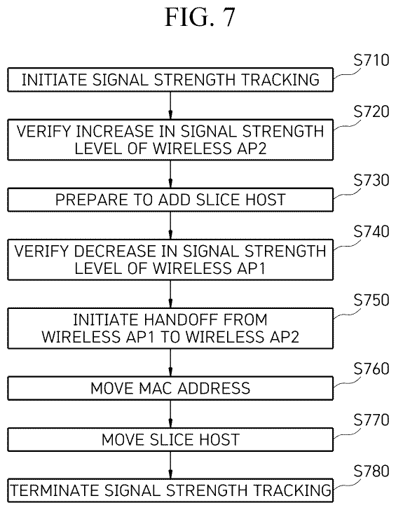

An algorithm for performing handoff when the user equipment (UE) moves from wireless AP1 cell A to area B, which overlaps with a wireless AP cell, is described below with reference to FIG. 7. The handoff process for maintaining network slicing service during inter-cell movement is described below step by step.

### Initiating Signal Strength Tracking (S710)

The user equipment (UE) initiates tracking the signal strength of wireless AP1. The wireless AP1 sends a signal strength tracking detection request and a slice host removal preparation request to the SDN controller and receives an ACK response from the SDN controller.

### Verifying Increase in Signal Strength Level of Wireless AP2 (S720)

The user equipment (UE) notifies the SDN controller when the increase in the signal strength level of wireless AP2 reaches a threshold value, and receives an ACK response from the SDN controller.

### Preparing to Add Slice Host (S730)

The user equipment (UE) tracks the signal strength of wireless AP2. The SDN controller sends a slice host addition preparation request to wireless AP2 and receives an ACK response.

### Verifying Decrease in Signal Strength Level (S740)

The user equipment (UE) notifies the SDN controller when the decrease in the signal strength level of wireless AP1 reaches a threshold value, and receives an ACK response from the SDN controller.

### Configuring Handoff (S750)

The user equipment (UE) initiates handoff from wireless AP1 to wireless AP2. The SDN controller verifies the monitoring results of environmental variables such as wireless transmission and reception signal strength, interference, and noise, and determines the signal strength tracking values using predetermined equations for handoff configuration.

### Moving MAC Address (S760)

The MAC address of the user equipment (UE) moves from wireless AP1 to wireless AP2. The SDN switch releases the MAC address of the user equipment (UE) from port 1 and registers the MAC address of the user equipment (UE) on port 2, based on control instructions from the SDN controller.

### Moving Slice Host (S770)

The slice host of the user equipment (UE) moves from a first slice to a second slice. The SDN controller releases the host of the user equipment (UE) from the first slice and registers the host of the user equipment (UE) to the second slice.

### Terminating Signal Strength Tracking (S780)

When the signal strength of wireless AP2 reaches a predetermined handoff termination signal strength, the user equipment (UE) requests the termination of tracking, and the SDN controller notifies the termination of signal strength tracking.

The SDN controller according to an embodiment of the present disclosure verifies monitoring information using the intelligent radio control and monitoring unit and sets the received signal value and the signal strength tracking value at the handoff transition point for handoff configuration in the base station and user equipment.

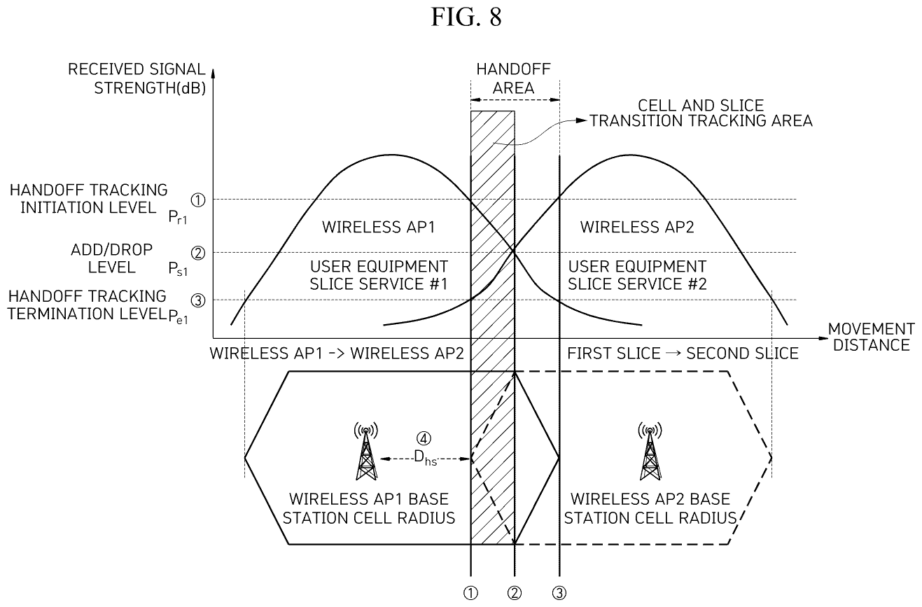

Equations for determining the received signal value and the signal strength tracking value are described below with reference to FIG. 8. The equations according to an embodiment of the present disclosure are programmed into the intelligent radio control and monitoring unit of the SDN controller and operate accordingly.

\textcircled{1} is the signal strength level (Pᵣ₁) for initiating handoff tracking, and the equation for determining this is shown below as [Equation 1].

$${P}_{r 1} [ dBm ] = {P}_{t} + {G}_{t} + {G}_{r} - {L}_{f} - {L}_{M} - offs \qquad [ Equation 1 ]$$

In this case, L_{f} [dB] is

$$20 {log}_{10} ( d ) + 20 {log}_{10} ( f ) + 20 {log}_{10} ( \frac{4 π}{c} ) ,$$

and L_{M} [dB] is 10 log₁₀(M), and offset [dB] refers to a compensation offset. The compensation offset is a value that compensates for the loss by receiving feedback from the intelligent radio control and monitoring unit.

The definitions of the symbols in [Equation 1] are as follows.
Pᵣ₁: The signal strength (dBm) received by the terminal from the signal transmitted by wireless AP1 base station
Pₜ: The transmitted power (dBm) from the wireless AP1 base station
Gᵣ: The transmit antenna gain (dBi) of the wireless AP1 base station
Gᵣ: The receive antenna gain (dBi) of the terminal
L_{f}: The transmission power loss in free space (dB)
L_{M}: The transmission power loss (dB) depending on the modulation scheme
offset: The compensation offset (0-3 dB) depending on the field environment
f: Frequency (Hz)
d: The distance between antennas (m)
C: The speed of light (3×10⁸ m/s)
M: The number of symbols depending on the modulation scheme

\textcircled{2} is where the service cell changes after handoff tracking (where the signal strength increases or decreases), and the equation for determining the signal strength transition level (Pₛ₁) for handoff is shown below as [Equation 2].

$${P}_{s 1} [ dBm ] = 10 {log}_{10} ( \frac{{P}_{s 2}}{1 mW} ( {2}^{\frac{C h}{B}} - 1 ) ) \qquad [ Equation 2 ]$$

The definitions of the symbols in [Equation 2] are as follows.
Ch: Channel transmission capacity (bps)
B: Channel allocation bandwidth (Hz)
Pₛ₁: The received signal power of the wireless AP1 base station (W)
Pₛ₂: The received signal power of the wireless AP2 base station (W) (This becomes the noise power of Pₛ₁)

\textcircled{3} is where the service cell changes after handoff tracking, and the equation for determining the signal strength level (Pₑ₁) at the point where handoff tracking terminates after the signal strength transition is shown below as [Equation 3].

$${P}_{e 1} [ dBm ] = {P}_{s 1} + ( {P}_{s 1} \times ( 0.1 \sim 0.05 ) ) \qquad [ Equation 3 ]$$

Pₑ₁ refers to the received power of the signal transmitted by wireless AP1 base station at \textcircled{3}, which is the tracking termination point (dBm) for the received signal strength of the wireless AP1 base station.
\textcircled{4} is the location (distance) where handoff tracking is initiated by the base station, which is the predetermined value of the initial handoff distance (Dₕₛ) used for environmental variable measurement and test software design during initial cell design, and is determined according to the following [Equation 4].

$${D}_{h s} [ m ] = \frac{C}{4 π f \cdot {10}^{α}} ( Note : speed of light C = 3 \times 1 {0}^{8} m / s ) \qquad [ Equation 4 ]$$

In this case, α is

$$\frac{{P}_{r 1} - {P}_{t} - {G}_{t} - {G}_{r} + {L}_{M} + offset}{20}$$

The definitions of the symbols in [Equation 4] are as follows.
Dₕₛ: The distance (m) from the base station to the handoff tracking initiation point, serving as the received power tracking point for handoff

As described above, Dₕₛ is the predetermined value for determining the handoff initiation point during cell design and for operating internal test programs. According to an embodiment of the present disclosure, handoff is optimized by calculating signal strength and distance for the network slicing-based handoff configuration.

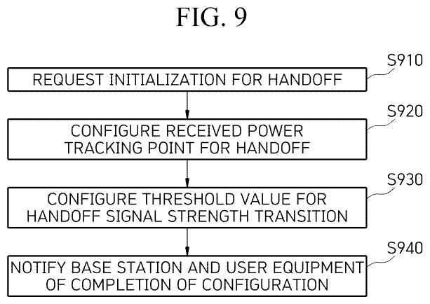

An initial signal strength configuration process for handoff according to an embodiment of the present disclosure is described below with reference to FIG. 9.

FIG. 9 shows a network slicing-based handoff process according to an embodiment of the present disclosure, specifically, an initial configuration process for handoff.

### Requesting Initialization of Signal Strength of Base Station and Terminal for Handoff (S910)

During the initial cell design, for determining the initiation point location in the cell overlap area, the base station and terminal request the SDN controller to set the distance (Dₕₛ) to the point where handoff tracking starts.

### Configuring Received Power Tracking Point (S920)

The SDN controller configures the received power tracking point for handoff and notifies the base station of the result. The SDN controller receives a request from the base station to configure a threshold value for the handoff signal strength transition.

### Configuring Signal Strength in Overlap Area (S930)

During the handoff process, the SDN controller completes the configuration of the signal strength (Pᵣ₁) at the handoff tracking initiation point, the signal strength (Pₛ₁) at the handoff transition point, and the signal strength (Pₑ₁) at the handoff tracking termination point.

### Notifying Configuration Completion (S940)

The SDN controller notifies the base station of the completion of the signal strength configuration, and the user equipment receives the configuration completion notification through the base station.

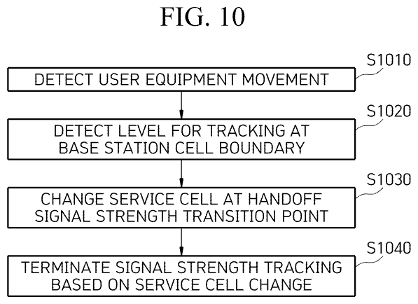

According to an embodiment of the present disclosure, after the initial configuration process, which uses the results of the signal strength configuration for handoff, is completed, the signal strength tracking and transition process for handoff is performed upon detecting the movement of the equipment. This is described below with reference to FIG. 10.

### Detecting User Equipment Movement (S1010)

The base station and SDN controller detects the movement of the user equipment through changes in the signal strength thereof and request signal strength tracking for handoff.

The user equipment and base station refer to the signal strength values in the pre-configured cell overlap area based on the initial configuration and transmit the real-time measured values to the intelligent radio control and monitoring unit.

### Detecting Level for Tracking at Base Station Cell Boundary (S1020)

During user equipment movement, the signal strength (Pᵣ₁) level at the handoff tracking initiation point is detected at the base station cell boundary (Dₕₛ).

### Changing Service Cell at Handoff Signal Strength Transition Point (S1030)

During user equipment movement, the base station detects the transition level (Pₛ₁) of the received signal strength and moves the existing MAC address and network slice host information to the changed service cell for service cell change.

### Terminating Signal Strength Tracking Based on Service Cell Change (S1040)

As the service cell change in the user equipment is completed, the handoff process is ultimately terminated when the signal strength reaches the termination level (Pₑ₁) of the signal strength tracking.

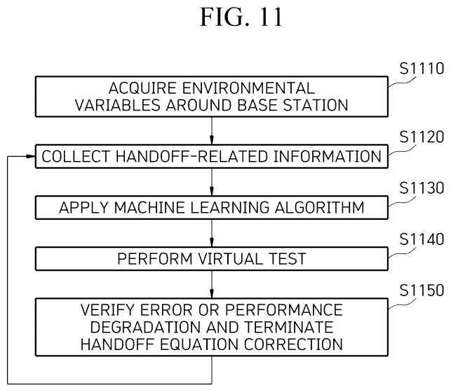

A process for improving the accuracy of the real-time equation values determined by the intelligent radio control and monitoring unit according to an embodiment of the present disclosure is described below with reference to FIG. 11. The intelligent radio control and monitoring unit included in the SDN controller performs operations to improve the accuracy of the soft handoff equation in real time.

### Acquiring Environmental Variables Around Base Station (S1110)

Environmental variables such as received signal strength, interference, and noise are measured using measurement equipment deployed in the field.

### Collecting Handoff-Related Information (S1120)

During the handoff process based on the user equipment movement, the position, speed, signal strength, and other variables of the moving equipment are collected in real time and the data is updated.

### Applying Machine Learning Algorithm (S1130)

Using machine learning algorithms, the relationship between environmental variables and handoff performance is learned, and a more accurate equation is derived to optimize the handoff computation.

### Performing Virtual Test (S1140)

Using the virtual testing program included in the SDN controller, tests on handoff equations are performed in various virtual environments such as urban, suburban, and indoor settings, and accuracy verification is performed in different scenarios.

### Verifying Error or Performance Degradation and Terminating Handoff Equation Correction (S1150)

If errors or performance degradation factors occur during the handoff process, data related to handoff failure rates, transmission speed reduction, and other related issues are analyzed, and correction of the handoff equation and the resulting values thereof is performed. If an error or performance degradation is found, the above-described steps S1120 to S1140 are repeatedly performed. According to an embodiment of the present disclosure, it is possible to improve the accuracy of the values resulting from the handoff equation through the above-described process.

The method for ensuring host mobility using a network slicing update system based on dynamic allocation of resources according to an embodiment of the present disclosure includes (a) detecting a movement of a host registered in a network slice, and (b) performing handoff using a data link layer without using an IP address in relation to the host's movement.

(a) is the step of detecting the movement of the host by receiving signal strength information from the base station and the host when the host, which refers to the user equipment, moves.

(a) is the step of detecting the movement of the host based on the signal strength level for initiating handoff tracking.

(a) is the step of receiving a preparation request to remove the host from a first network slice that the host is previously part of, and a preparation request to add the host to a second network slice that the host is to be part of, based on a change in the received signal strength information.

(b) is the step of moving the host's MAC address from the MAC layer, which is a lower layer of the data link layer, based on a decrease in the signal strength level of a first base station that corresponds to the first network slice, and an increase in the signal strength level of a second base station that corresponds to the second network slice.

(b) is the step of performing the handoff based on the signal strength level at the handoff transition point.

(b) is the step of terminating the handoff based on the received signal power sent from the first base station and the signal strength level at the handoff tracking termination point.

(b) is the step of receiving environmental variables, including wireless transmission/reception signal strength, interference, and noise, from field equipment, learning the relationship between the environmental variables and handoff performance, and adjusting the received signal strength settings related to the handoff.

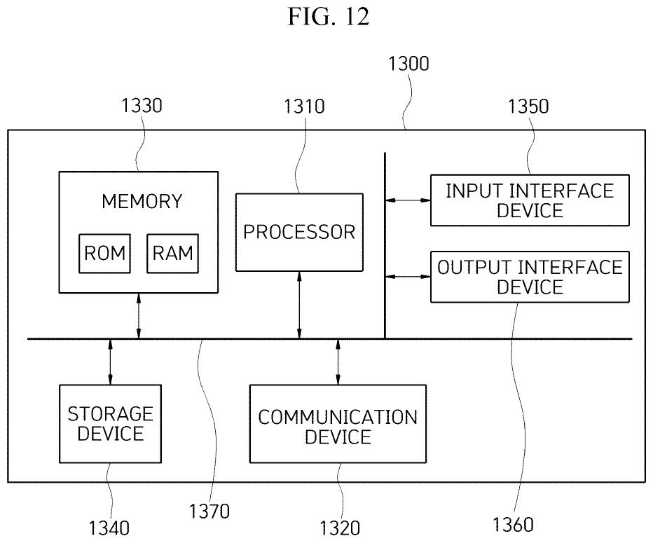

FIG. 12 is a block diagram showing a computer system for implementing a method according to an embodiment of the present disclosure.

Referring to FIG. 12, a computer system 1300 may include at least one of a processor 1313, memory 1330, an input interface device 1350, an output interface device 1360, and a storage device 1340, which communicate through a bus 1370. The computer system 1300 may include a communication device 1320 connected to a network. The processor 1310 may be a central processing unit (CPU) or a semiconductor device that executes instructions stored in the memory 1330 or storage device 1340. The memory 1330 and storage device 1340 may include various types of volatile or non-volatile storage media. For example, memory may include read only memory (ROM) and random access memory (RAM). In the embodiment of the present disclosure, the memory may be located inside or outside the processor, and the memory may be connected to the processor through various known means. The memory is a type of volatile or non-volatile storage medium in various forms. For example, the memory may include read-only memory (ROM) or random access memory (RAM).

Therefore, an embodiment of the present disclosure may be implemented as a method executed by a computer, or as a non-transitory computer-readable medium where computer-executable instructions are stored. In an embodiment, when executed by a processor, the computer-readable instructions may perform a method according to at least one aspect of the present disclosure.

The communication device 1320 may transmit or receive a wired or wireless signal.

In addition, the method according to an embodiment of the present disclosure may be implemented in the form of program instructions that may be executed through various computer means and recorded on computer-readable media.

The computer-readable media may include program instructions, data files, data structures, and the like, either alone or in combination. The program instructions recorded on the computer-readable media may be specifically designed and configured for the embodiment of the present disclosure, or may be known and available to those skilled in the field of computer software. The computer-readable recording media may include hardware devices configured to store and execute program instructions. For example, the computer-readable recording media may be magnetic media such as hard disks, floppy disks, and magnetic tapes, optical media such as CD-ROMs and DVDs, magneto-optical media such as floptical disks, ROMs, RAMs, flash memory, etc. The program instructions may include machine language code, such as that produced by a compiler, as well as high-level language code that may be executed by a computer through an interpreter or the like.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A network slicing update system based on dynamic allocation of resources, the system comprising:
an update request receiving unit configured to receive network slicing update requests;
a target host removal identification and resource release unit configured to identify a host to be removed and release resources based on the update request; and
a target host addition identification and resource allocation unit configured to identify a host to be added and allocate resources.

2. The system of claim 1, wherein the target host removal identification and resource release unit compares a set of hosts in a previous virtual dedicated network with a set of hosts in an updated virtual dedicated network to identify the host to be removed.

3. The system of claim 2, wherein the target host removal identification and resource release unit uses a set difference between the set of hosts in the previous virtual dedicated network and the set of hosts in the updated virtual dedicated network to identify the host to be removed.

4. The system of claim 1, wherein the target host removal identification and resource release unit removes flow rules related to the host to be removed and releases unnecessary network resources from a virtual dedicated network.

5. The system of claim 4, wherein the target host removal identification and resource release unit removes only flow rules and maintains network resources when the host to be removed is part of an edge switch connected to other hosts in the virtual dedicated network.

6. The system of claim 1, wherein the target host addition identification and resource allocation unit uses a set of hosts in an updated virtual dedicated network and a set of hosts in a previous virtual dedicated network to identify the host to be added.

7. The system of claim 6, wherein the target host addition identification and resource allocation unit uses a set difference between the set of hosts in the updated virtual dedicated network and the set of hosts in the previous virtual dedicated network to identify the host to be added.

8. The system of claim 1, wherein the target host addition identification and resource allocation unit reconfigures a central node when a virtual dedicated network tree is modified by an edge node of the host to be added.

9. A method for ensuring host mobility using a network slicing update system based on dynamic allocation of resources, the method comprising:
(a) detecting a movement of a host registered in a network slice; and
(b) performing handoff using a data link layer without using an IP address in relation to the host's movement.

10. The method of claim 9, wherein the (a) is detecting the movement of the host by receiving signal strength information from a base station and the host, when the host, which refers to user equipment, moves.

11. The method of claim 10, wherein the (a) is detecting the movement of the host based on a signal strength level for initiating handoff tracking.

12. The method of claim 10, wherein the (a) is receiving a preparation request to remove the host from a first network slice that the host is part of, and a preparation request to add the host to a second network slice that the host is to be part of, based on a change in the received signal strength information.

13. The method of claim 12, wherein the (b) is moving the host's MAC address from MAC layer, which is a lower layer of a data link layer, based on a decrease in a signal strength level of a first base station that corresponds to the first network slice, and an increase in a signal strength level of a second base station that corresponds to the second network slice.

14. The method of claim 13, wherein the (b) is performing the handoff based on a signal strength level at a handoff transition point.

15. The method of claim 12, wherein the (b) is terminating the handoff based on received signal power sent from a first base station and a signal strength level at a handoff tracking termination point.

16. The method of claim 9, wherein the (b) is receiving environmental variables, including wireless transmission/reception signal strength, interference, and noise, from field equipment, learning relationship between the environmental variables and handoff performance, and adjusting received signal strength settings related to the handoff.
